(19) United States
(12) Patent Application Publication
(10) Pub. No.: US 2023/0385935 A1
(43) Pub. Date: Nov. 30, 2023

(54) METHOD AND SYSTEM FOR AUTOMATED RULE-BASED ALLOCATIONS

(71) Applicant: JPMorgan Chase Bank, N.A., New York, NY (US)

(72) Inventors: Paul PRZYBYLSKI, Holmdel, NJ (US); Joseph G VITTORIA, Stamford, CT (US); Keshav HAVNURKAR, Hackensack, NJ (US); Venugopal KOLLI, Plainsboro, NJ (US); Daniel A TAFOYA, Plaistow, NH (US)

(73) Assignee: JPMorgan Chase Bank, N.A., New York, NY (US)

(21) Appl. No.: 18/201,933

(22) Filed: May 25, 2023

Related U.S. Application Data
(60) Provisional application No. 63/365,383, filed on May 26, 2022.

(51) Int. Cl. G06Q 40/06

(52) U.S. Cl. CPC G06Q 40/06

(57) ABSTRACT

A method for facilitating automated rule-based asset allocation is disclosed. The method includes onboarding, via a graphical user interface, clients based on corresponding client information; generating rules that correspond to the clients, the rules relating to asset allocation rules; retrieving, via an application programming interface, asset portfolio information that corresponds to the clients; determining an allocation action based on the generated rules and the asset portfolio information; and automatically initiating, in real-time, the allocation action.

### CROSS-REFERENCE TO RELATED APPLICATIONS

This application claims the benefit of U.S. Provisional Patent Application Ser. No. 63/365,383, filed May 26, 2022, which is hereby incorporated by reference in its entirety.

### BACKGROUND

### 1. Field of the Disclosure

This technology generally relates to methods and systems for asset allocations, and more particularly to methods and systems for facilitating automated asset allocations in real-time by using rule-based programming.

### 2. Background Information

Many business entities rely on complex rules such as, for example, asset allocation rules to satisfy business and regulatory objectives. Often, the complex rules are implemented as intricately choreographed actions such as, for example, asset transfers and offsetting transactions. Historically, conventional implementations of rule management techniques have resulted in varying degrees of success with respect to effective and timely satisfaction of the business and regulatory objectives.

One drawback of using the conventional rule management techniques is that in many instances, the complex rules are individually processed based on fluctuating variables such as, for example, changing market conditions. As such, daily and weekly decisions required for maintaining the business and regulatory objectives require large investments in time and resources. Additionally, due to the complex nature of the rules, the choreographed actions are not able to be automatically processed in real-time.

Therefore, there is a need to facilitate automated processing of the complex rules in real-time by using rule-based programming.

### SUMMARY

The present disclosure, through one or more of its various aspects, embodiments, and/or specific features or sub-components, provides, inter alia, various systems, servers, devices, methods, media, programs, and platforms for facilitating automated asset allocations in real-time by using rule-based programming.

According to an aspect of the present disclosure, a method for facilitating automated rule-based asset allocation is disclosed. The method is implemented by at least one processor. The method may include onboarding, via a graphical user interface, at least one client based on corresponding client information; generating at least one rule that corresponds to the at least one client, the at least one rule may relate to an asset allocation rule; retrieving, via an application programming interface, asset portfolio information that corresponds to the at least one client; determining at least one allocation action based on the at least one rule and the asset portfolio information; and automatically initiating, in real-time, the at least one allocation action.

In accordance with an exemplary embodiment, to generate the at least one rule, the method may further include identifying at least one predetermined criterion from the corresponding client information; generating the at least one rule based on the at least one predetermined criterion, the at least one rule may include software code that implements the at least one predetermined criterion; and initiating at least one testing action for the generated at least one rule, the at least one testing action may include a user acceptance testing action.

In accordance with an exemplary embodiment, the at least one predetermined criterion may include a daily net target allocation criterion that relates to maintaining a target balance for an asset portfolio and a daily end of day round-trip criterion that relates to offsetting transactions for the asset portfolio.

In accordance with an exemplary embodiment, the method may further include automatically generating at least one log for each of the initiated at least one allocation action, the at least one log may include information that relates to the at least one client, the at least one rule, the asset portfolio information, and the at least one allocation action; associating the at least one log with the corresponding at least one client; and persisting the at least one log together with the association in a repository.

In accordance with an exemplary embodiment, the method may further include automatically generating, in real-time, a notification for each of the initiated at least one allocation action, the notification may include information that relates to the at least one rule, the asset portfolio information, and the at least one allocation action; and transmitting the notification to the corresponding at least one client.

In accordance with an exemplary embodiment, the method may further include automatically determining at least one error condition when the at least one allocation action is not successfully initiated; generating an alert for each of the at least one error condition, the alert may include information that relates to the at least one allocation action and the at least one error condition; and transmitting the alert to at least one responsible party.

In accordance with an exemplary embodiment, the method may further include automatically determining, based on at least one predetermined resolution guideline, at least one resolution action for each of the at least one error condition; and automatically initiating the at least one resolution action to resolve the corresponding at least one error condition.

In accordance with an exemplary embodiment, the method may further include automatically determining a severity level for each of the at least one error condition according to a predetermined severity guideline; ranking the at least one error condition based on the severity level; and automatically initiating the at least one resolution action based on a result of the ranking, wherein the severity level may be automatically determined by using information that relates to the at least one allocation action and the at least one error condition.

In accordance with an exemplary embodiment, the at least one allocation action may include an equal and offsetting action that is scheduled for a predetermined time, the predetermined time may include a future time when the at least one allocation action is automatically initiated.

According to an aspect of the present disclosure, a computing device configured to implement an execution of a method for facilitating automated rule-based asset allocation is disclosed. The computing device including a processor; a memory; and a communication interface coupled to each of the processor and the memory, wherein the processor may be configured to onboard, via a graphical user interface, at least one client based on corresponding client information; generate at least one rule that corresponds to the at least one client, the at least one rule may relate to an asset allocation rule; retrieve, via an application programming interface, asset portfolio information that corresponds to the at least one client; determine at least one allocation action based on the at least one rule and the asset portfolio information; and automatically initiate, in real-time, the at least one allocation action.

In accordance with an exemplary embodiment, to generate the at least one rule, the processor may be further configured to identify at least one predetermined criterion from the corresponding client information; generate the at least one rule based on the at least one predetermined criterion, the at least one rule may include software code that implements the at least one predetermined criterion; and initiate at least one testing action for the generated at least one rule, the at least one testing action may include a user acceptance testing action.

In accordance with an exemplary embodiment, the at least one predetermined criterion may include a daily net target allocation criterion that relates to maintaining a target balance for an asset portfolio and a daily end of day round-trip criterion that relates to offsetting transactions for the asset portfolio.

In accordance with an exemplary embodiment, the processor may be further configured to automatically generate at least one log for each of the initiated at least one allocation action, the at least one log may include information that relates to the at least one client, the at least one rule, the asset portfolio information, and the at least one allocation action; associate the at least one log with the corresponding at least one client; and persist the at least one log together with the association in a repository.

In accordance with an exemplary embodiment, the processor may be further configured to automatically generate, in real-time, a notification for each of the initiated at least one allocation action, the notification may include information that relates to the at least one rule, the asset portfolio information, and the at least one allocation action; and transmit the notification to the corresponding at least one client.

In accordance with an exemplary embodiment, the processor may be further configured to automatically determine at least one error condition when the at least one allocation action is not successfully initiated; generate an alert for each of the at least one error condition, the alert may include information that relates to the at least one allocation action and the at least one error condition; and transmit the alert to at least one responsible party.

In accordance with an exemplary embodiment, the processor may be further configured to automatically determine, based on at least one predetermined resolution guideline, at least one resolution action for each of the at least one error condition; and automatically initiate the at least one resolution action to resolve the corresponding at least one error condition.

In accordance with an exemplary embodiment, the processor may be further configured to automatically determine a severity level for each of the at least one error condition according to a predetermined severity guideline; rank the at least one error condition based on the severity level; and automatically initiate the at least one resolution action based on a result of the ranking, wherein the severity level may be automatically determined by using information that relates to the at least one allocation action and the at least one error condition.

In accordance with an exemplary embodiment, the at least one allocation action may include an equal and offsetting action that is scheduled for a predetermined time, the predetermined time may include a future time when the at least one allocation action is automatically initiated.

According to an aspect of the present disclosure, a non-transitory computer readable storage medium storing instructions for facilitating automated rule-based asset allocation is disclosed. The storage medium including executable code which, when executed by a processor, may cause the processor to onboard, via a graphical user interface, at least one client based on corresponding client information; generate at least one rule that corresponds to the at least one client, the at least one rule may relate to an asset allocation rule; retrieve, via an application programming interface, asset portfolio information that corresponds to the at least one client; determine at least one allocation action based on the at least one rule and the asset portfolio information; and automatically initiate, in real-time, the at least one allocation action.

In accordance with an exemplary embodiment, to generate the at least one rule, the executable code, when executed by the processor, may further cause the processor to identify at least one predetermined criterion from the corresponding client information; generate the at least one rule based on the at least one predetermined criterion, the at least one rule may include software code that implements the at least one predetermined criterion; and initiate at least one testing action for the generated at least one rule, the at least one testing action may include a user acceptance testing action.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating automated asset allocations in real-time by using rule-based programming.

FIG. 4 is a flowchart of an exemplary process for implementing a method for facilitating automated asset allocations in real-time by using rule-based programming.

FIG. 5 is a flow diagram of an exemplary rule authorization process for implementing a method for facilitating automated asset allocations in real-time by using rule-based programming.

FIG. 6 is a flow diagram of an exemplary daily net allocation process for implementing a method for facilitating automated asset allocations in real-time by using rule-based programming.

FIG. 7 is a flow diagram of an exemplary daily end of day round-trip process for implementing a method for facilitating automated asset allocations in real-time by using rule-based programming.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

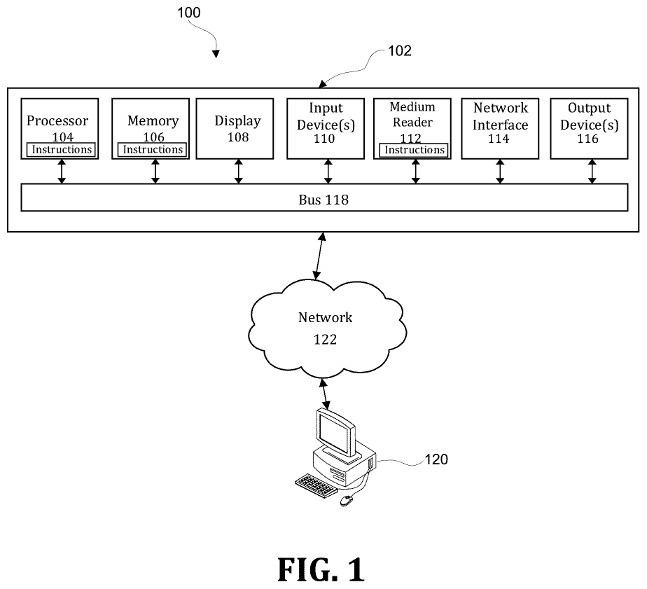

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons of skill in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating automated asset allocations in real-time by using rule-based programming.

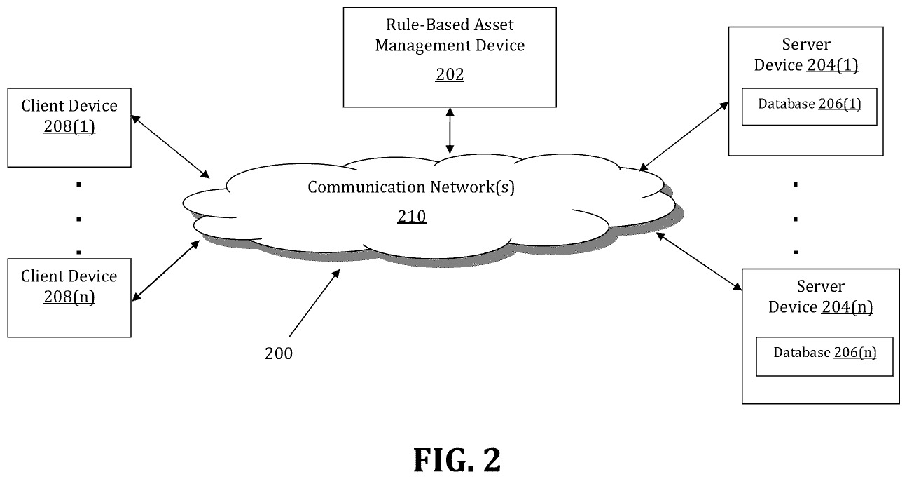

Referring to FIG. 2, a schematic of an exemplary network environment 200 for implementing a method for facilitating automated asset allocations in real-time by using rule-based programming is illustrated. In an exemplary embodiment, the method is executable on any networked computer platform, such as, for example, a personal computer (PC).

The method for facilitating automated asset allocations in real-time by using rule-based programming may be implemented by a Rule-Based Asset Management (RBAM) device 202. The RBAM device 202 may be the same or similar to the computer system 102 as described with respect to FIG. 1. The RBAM device 202 may store one or more applications that can include executable instructions that, when executed by the RBAM device 202, cause the RBAM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the RBAM device 202 itself, may be located in virtual server(s) running in a cloud-based computing environment rather than being tied to one or more specific physical network computing devices. Also, the application(s) may be running in one or more virtual machines (VMs) executing on the RBAM device 202. Additionally, in one or more embodiments of this technology, virtual machine(s) running on the RBAM device 202 may be managed or supervised by a hypervisor.

In the network environment 200 of FIG. 2, the RBAM device 202 is coupled to a plurality of server devices 204(1)-204(n) that hosts a plurality of databases 206(1)-206(n), and also to a plurality of client devices 208(1)-208(n) via communication network(s) 210. A communication interface of the RBAM device 202, such as the network interface 114 of the computer system 102 of FIG. 1, operatively couples and communicates between the RBAM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RBAM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and RBAM devices that efficiently implement a method for facilitating automated asset allocations in real-time by using rule-based programming.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The RBAM device 202 may be a standalone device or integrated with one or more other devices or apparatuses, such as one or more of the server devices 204(1)-204(n), for example. In one particular example, the RBAM device 202 may include or be hosted by one of the server devices 204(1)-204(n), and other arrangements are also possible. Moreover, one or more of the devices of the RBAM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the RBAM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to client information, allocation rules, asset portfolio information, allocation actions, predetermined criteria, logs, and notifications.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the RBAM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the RBAM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the RBAM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the RBAM device 202, the server devices 204(1)-204(n), or the client devices 208(1)-208(n), for example, may be configured to operate as virtual instances on the same physical machine. In other words, one or more of the RBAM device 202, the server devices 204(1)-204(n), or the client devices 208(1)-208(n) may operate on the same physical device rather than as separate devices communicating through communication network(s) 210. Additionally, there may be more or fewer RBAM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

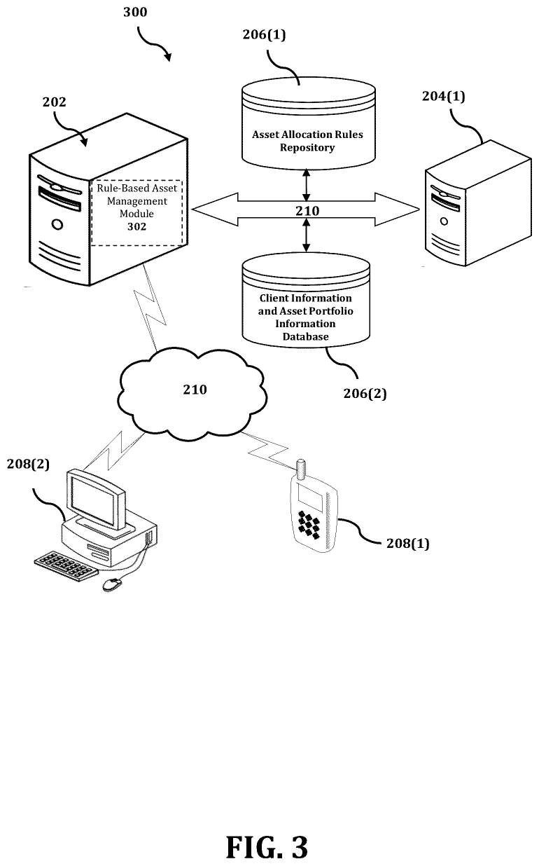

The RBAM device 202 is described and shown in FIG. 3 as including a rule-based asset management module 302, although it may include other rules, policies, modules, databases, or applications, for example. As will be described below, the rule-based asset management module 302 is configured to implement a method for facilitating automated asset allocations in real-time by using rule-based programming.

An exemplary process 300 for implementing a mechanism for facilitating automated asset allocations in real-time by using rule-based programming by utilizing the network environment of FIG. 2 is shown as being executed in FIG. 3. Specifically, a first client device 208(1) and a second client device 208(2) are illustrated as being in communication with RBAM device 202. In this regard, the first client device 208(1) and the second client device 208(2) may be “clients” of the RBAM device 202 and are described herein as such. Nevertheless, it is to be known and understood that the first client device 208(1) and/or the second client device 208(2) need not necessarily be “clients” of the RBAM device 202, or any entity described in association therewith herein. Any additional or alternative relationship may exist between either or both of the first client device 208(1) and the second client device 208(2) and the RBAM device 202, or no relationship may exist.

Further, RBAM device 202 is illustrated as being able to access an asset allocation rules repository 206(1) and a client information and asset portfolio information database 206(2). The rule-based asset management module 302 may be configured to access these databases for implementing a method for facilitating automated asset allocations in real-time by using rule-based programming.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the RBAM device 202 via broadband or cellular communication. Of course, these embodiments are merely exemplary and are not limiting or exhaustive.

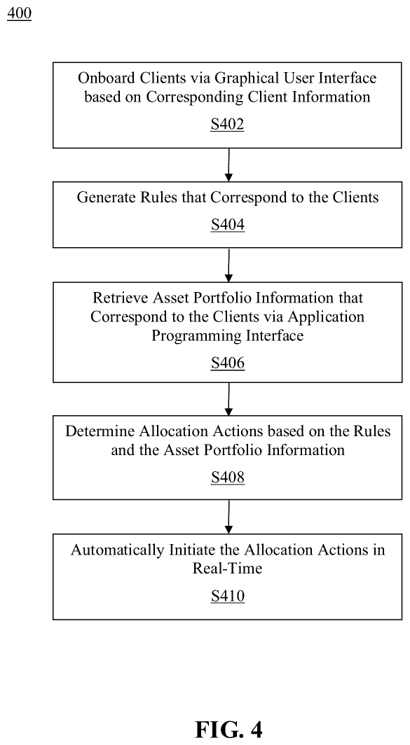

Upon being started, the rule-based asset management module 302 executes a process for facilitating automated asset allocations in real-time by using rule-based programming. An exemplary process for facilitating automated asset allocations in real-time by using rule-based programming is generally indicated at flowchart 400 in FIG. 4.

In the process 400 of FIG. 4, at step S402, clients may be onboarded based on corresponding client information. The clients may be onboarded via a graphical user interface. In an exemplary embodiment, the clients may directly interact with the graphical user interface to provide the corresponding client information. For example, the clients may facilitate the onboarding process by directly interacting with the graphical user interface to input the corresponding client information. In another exemplary embodiment, the clients may indirectly interact with the graphical user interface to provide the corresponding client information. For example, the clients may provide the corresponding client information in a form to a representative, who then interacts with the graphical user interface to facilitate the onboarding process.

In another exemplary embodiment, the graphical user interface may correspond to an interface that facilitates interactions between a user and computing components. The graphical user interface may include graphical icons and audio indicators. In another exemplary embodiment, the graphical user interface may relate to a system of interactive visual components for computer software. The graphical user interface may display objects that convey information and represent actions that can be taken by the user. For example, the clients may interact with the displayed objects to input the corresponding client information. In another exemplary embodiment, the displayed objects may automatically change based on the client inputs. For example, an input A by the clients may cause information B and/or input field C to be displayed for the clients.

In another exemplary embodiment, the onboarding may relate to an incorporation process that facilitates integration of client systems with the claimed invention. The clients may be required to provide necessary information such as, for example, client account information as well as perform necessary actions such as, for example, open compatible accounts.

In another exemplary embodiment, in order to leverage features consistent with present disclosures, the clients may begin the onboarding process by opening a cleared account and/or open accounts which are activated via global models. The clients may complete authorization forms and designate a responsible party associated with each of the clients as a client administrator. Then, the clients may continue to onboard relevant accounts with a payment network such as, for example, a SWIFT payment network by submitting authorization forms that correspond to the payment network. The client may also schedule regular daily balance reports at intervals such as, for example, twice per cut-off per day.

In another exemplary embodiment, as part of the onboarding process, the clients may first determine a list of investments to be leveraged as part of an optimized structure by completing an authorization form for each bank account that will be included for allocation purposes. The clients may provide key information through the authorization form. The key information may include target account balance information, investment account allocation information, notification contact list information, priority information, allocation percentage and/or allocation amount information, and round-trip information.

The target account balance information may include a target account balance that must be determined in order to determine the amount of investment or redemption required. The investment account allocation information may include client instructions for how assets will be split when there are multiple investment accounts associated with the client account. The split may be provided based on percentages or as a dollar value according to a predetermined account priority. The notification contact list information may include a list of collected contacts where email notifications may be sent when the trades are placed or when there are errors and required remediation.

The priority information may include a priority order of funds to be invested. The assets may be invested in highest priority funds first and redeemed out of lowest priority funds first for cascade allocations. For allocations based on percentages, all funds selected may have equal priority. The allocation percentage and/or allocation amount information may include an amount to be allocated to each position selected. For allocation amounts, all funds are invested in a cascading order, i.e., highest priority is invested in until the condition is met, then move to the next priority. For allocation percentages, all funds may be invested in based on the percentage allocation. The round-trip information may include determining whether trades placed will automatically create a forward-dated, round-trip transaction to pull assets back into the client account the next day.

In another exemplary embodiment, the asset may correspond to any resource that is owned or controlled by the clients. The assets may correspond to tangible items such as, for example, real estate holdings and intangible items such as, for example, stocks that provide economic value for the client. In another exemplary embodiment, the assets may correspond to financial instruments that are monetary contracts between a plurality of parties. The financial instruments may include cash instruments and derivative instruments. The financial instruments may be divided according to asset classes such as, for example, debt-based financial instruments and equity based financial instruments.

At step S404, rules that correspond to the clients may be generated. The rules may relate to asset allocation rules. Consistent with present disclosures, the rules may be generated for each of the clients. In an exemplary embodiment, generating the rules may include identifying predetermined criteria from the corresponding client information. The predetermined criteria may relate to a set of instructions that are provided by the clients in the corresponding client information. Then, the rules may be generated based on the predetermined criteria. The rules may include software code that implements the set of instructions associated with the predetermined criteria. Testing actions may also be initiated for the generated rules as part of the generating process. The testing actions may include a user acceptance testing (UAT) action.

In another exemplary embodiment, the predetermined criteria may include a daily net target allocation criterion that relates to maintaining a target balance for an asset portfolio and a daily end of day round-trip criterion that relates to offsetting transactions for the asset portfolio. The predetermined criteria may relate to operating models offered via the claimed system consistent with present disclosures.

In another exemplary embodiment, for the daily net target allocation criterion, clients may designate a target account balance that should remain in the target account after each day. At the time that the rules are run, the current account balance may be compared to the target account balance and trades may be placed in amounts equal to a difference between the two balances. For example, when the current account balance exceeds the target account balance, purchase transactions may be automatically placed by the claimed invention in real-time. Conversely, when the current account balance is lower than the target account balance, redemption transactions may be automatically placed by the claimed invention in real-time. When the current account balance is the same as the target account balance, no transactions are required.

In another exemplary embodiment, the daily end of day round-trip criterion may operate similar to the daily net target allocation criterion in relation to the target account balance comparison with the current account balance and the initial trade determinations. For example, when the comparison between the target account balance and the current account balance results in a purchase trade, equal and offsetting redemption trades may be placed for the next available business day. The redemption trades may be executed automatically at the first strike of the next day and resulting proceeds may be deposited back into the client account. Conversely, when the current account balance is below the target account balance, no trades are placed for the day.

In another exemplary embodiment, the rules may be defined by the clients to allocate cash based on either percentage investment breakouts or by priority. When the allocations are defined by percentages, the investments may be made across all positions and accounts based on the percentages as assigned. When the allocations are defined by nominal value, the investments may be made in priority order until the allocation levels have been reached. Redemptions, where applicable, may be placed in the reverse order of the priority as defined.

In another exemplary embodiment, the testing action may include internal UAT testing in a development environment. Once the internal UAT testing is sufficiently satisfied, the clients may be re-engaged to commence co-testing in a production environment with small amounts to validate that everything is working as intended. In another exemplary embodiment, for post onboarding modifications, all rules may be tested after each release to ensure that there are no defects. When defects are identified, the rules will not be processed until defects are remediated.

At step S406, asset portfolio information that corresponds to the clients may be retrieved. The asset portfolio information may be retrieved via an application programming interface. In an exemplary embodiment, the asset portfolio information may correspond to client account information consistent with present disclosures. The asset portfolio information may include asset type information for a plurality of assets in a client portfolio, asset amount information for each of the plurality of assets, and pending transaction information associated with each of the plurality of assets.

In another exemplary embodiment, the asset portfolio information may be retrieved directly from client systems as well as retrieved from a third-party associated with the clients. For example, the asset portfolio information for client A may be retrieved from bank B, which is a banking institution associated with client A. In another exemplary embodiment, the asset portfolio information may be retrieved based on a predetermined schedule. Consistent with present disclosures, the clients may indicate a time of balance reporting during the onboarding process.

At step S408, allocation actions may be determined based on the rules and the asset portfolio information. Consistent with present disclosures, the allocation actions may be determined based on each of the rules and the corresponding asset portfolio information. In an exemplary embodiment, the allocation actions may correspond to instructions to automatically initiate a transaction. Consistent with present disclosures, the allocation actions may correspond to a purchasing action when the current account balance exceeds the target account balance. Similarly, the allocation actions may correspond to a redemption action when the current account balance is lower than the target account balance.

At step S410, the allocation actions may be automatically initiated in real-time. Consistent with present disclosures, the allocation actions may be automatically initiated in any combination including asynchronous initiation and synchronous initiation. In an exemplary embodiment, the allocation actions may be automatically initiated according to the rules and the client information. The allocation actions may be initiated in real-time to facilitate at least one from among a purchasing action and a redemption action consistent with present disclosures.

In another exemplary embodiment, a log for each of the initiated allocation actions may be automatically generated. The log may include information that relates to the clients, the rules, the asset portfolio information, and the allocation actions. Then, the generated log may be associated with the corresponding clients. The log may be persisted together with the association in a repository. As will be appreciated by a person of ordinary skill in the art, the log may be usable as documentation of automatically initiated allocation actions.

In another exemplary embodiment, a notification may be automatically generated for each of the initiated allocation actions. The notification may include information that relates to the rules, the asset portfolio information, and the allocation actions. Then, the notification may be transmitted to the corresponding client according to information provided by the clients during the onboarding process. For example, the clients may provide during onboarding that the notification is to be emailed to a designated representative.

In another exemplary embodiment, three types of email notifications may be generated as part of normal day-to-day operations. The email notifications may include a cash optimizer trade notification, a rule error notification, and a standard trade notification. For the cash optimizer trade notification, clients may receive trade notification emails that provide details on all of the trades that will be placed based on the rules. The cash optimizer trade notifications may be sent to the client distribution list included in the authorization form.

When trades are not processed appropriately, or when the process to generate trades fail, rule error notification emails may be sent to a group of individuals to report the issue at the typical time of trade processing. The rule error notifications may be sent externally by using the client distribution lists as well as internally to a client services coverage team. For the standard trade notifications, trade notifications may be created normally to provide statuses for the transactions after the trades are processed. The standard trade notifications may be generated based on a predetermined user preference.

In another exemplary embodiment, an error condition may be automatically determined when the allocation action is not successfully initiated. Then, an alert for the error condition may be generated. The alert may include information that relates to the allocation action and the corresponding error condition. The alert may be transmitted to the corresponding client according to information provided by the clients during the onboarding process. For example, the clients may provide during onboarding that the notification is to be emailed to a designated representative.

In another exemplary embodiment, the error conditions may include a missing balance file error, an insufficient investment balance error, a technology failure error, a trade failure at transfer agent and/or clearing agent error, and a trade failure after being confirmed error. The missing balance file error may relate to an inability to locate the balance files after a predetermined period of time. The insufficient investment balance error may relate to insufficient investment balances, based on the best information available, for redemption proceeds to bring the current account balance up to meet the target account balance.

The technology failure error may relate to an error detected in any connected computing system. The trade failure at transfer agent and/or clearing agent error may relate to an error that is detected when the trades do not pass through to the transfer agent appropriately or when the trades are rejected by the transfer agent due to account related issues. The trade failure after being confirmed may relate to a trade failure after being confirmed by the transfer agent.

In another exemplary embodiment, the determined error condition may be automatically resolved based on predetermined guidelines. For example, when a trade is rejected due to a connection interface timing out resulting in an error condition, the claimed invention may automatically resolve the error condition by resubmitting the trade. In another exemplary embodiment, the determined error condition may be ranked based on a predetermined severity level. The error condition may be automatically resolved based on the predetermined severity level. For example, minor errors associated with a low severity level may be automatically resolved while major errors associated with a high severity level may require administrative intervention.

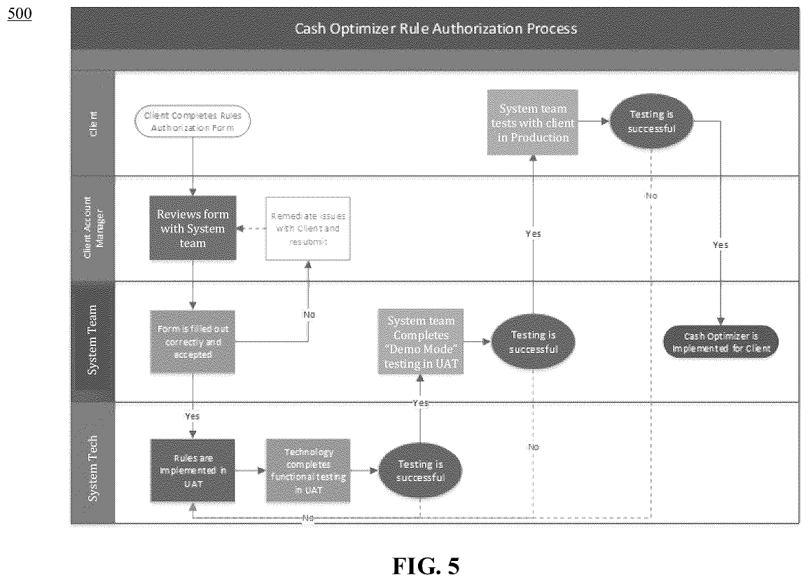

FIG. 5 is a flow diagram 500 of an exemplary rule authorization process for implementing a method for facilitating automated asset allocations in real-time by using rule-based programming. In FIG. 5, the rule authorization process may correspond to the client onboarding process consistent with present disclosures.

As illustrated in FIG. 5, clients may initiate the rule authorization process by completing the rules authorization form. The forms may be validated to ensure that information is correctly provided. Based on a result of the validation, the rules may be implemented for user acceptance testing (UAT) in a development environment. When the rules successfully pass the UAT testing, the rules may be tested in a production environment with client systems. The rules may be implemented for the client when all necessary testing is satisfied.

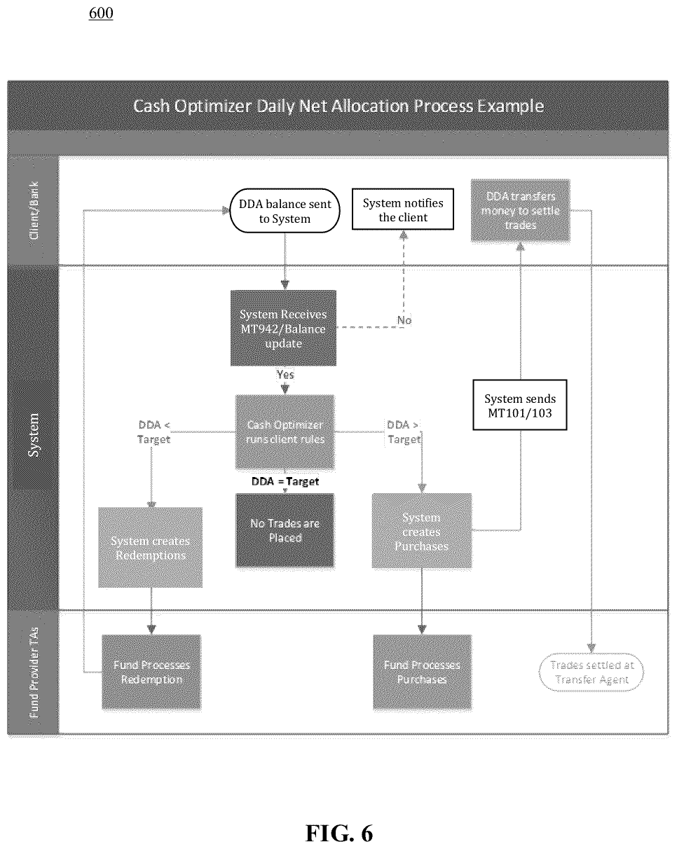

FIG. 6 is a flow diagram 600 of an exemplary daily net allocation process for implementing a method for facilitating automated asset allocations in real-time by using rule-based programming. In FIG. 6, the daily net allocation process may allow clients to set up rules to allocate balances toward trades at designated times.

As illustrated in FIG. 6, clients may designate a target account balance that should remain in the target account after each day for the daily net target allocation process. At the time that the rules are run, the current account balance may be compared to the target account balance and trades may be placed in amounts equal to a difference between the two balances. For example, when the current account balance exceeds the target account balance, purchase transactions may be automatically placed by the claimed invention in real-time. Conversely, when the current account balance is lower than the target account balance, redemption transactions may be automatically placed by the claimed invention in real-time. When the current account balance is the same as the target account balance, no transactions are required.

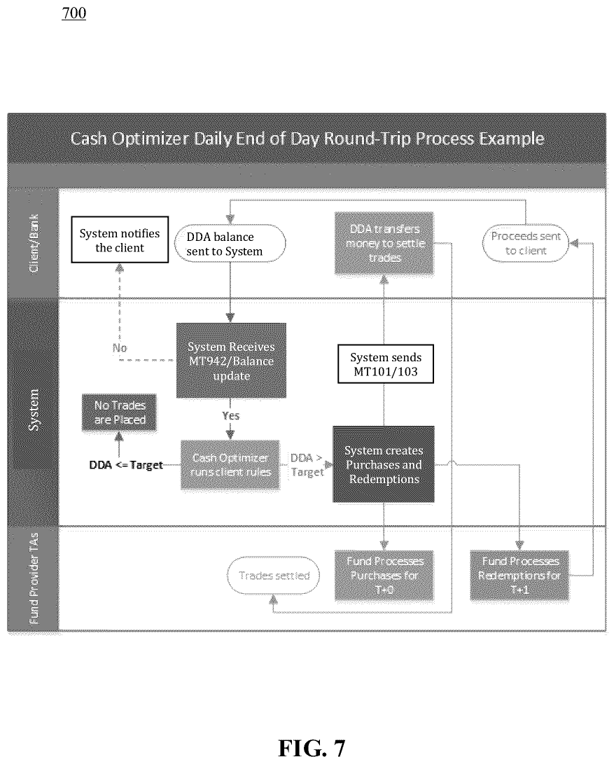

FIG. 7 is a flow diagram 700 of an exemplary daily end of day round-trip process for implementing a method for facilitating automated asset allocations in real-time by using rule-based programming. In FIG. 7, the daily end of day round-trip process may allow clients to set up rules to allocate balances toward trades at designated times.

As illustrated in FIG. 7, the daily end of day round-trip process may operate similar to the daily net target allocation process in relation to the target account balance comparison with the current account balance and the initial trade determinations. For example, when the comparison between the target account balance and the current account balance results in a purchase trade, equal and offsetting redemption trades may be placed for the next available business day. The redemption trades may be executed automatically at the first strike of the next day and resulting proceeds may be deposited back into the client account. Conversely, when the current account balance is below the target account balance, no trades are placed for the day.

Accordingly, with this technology, an optimized process for facilitating automated asset allocations in real-time by using rule-based programming is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating automated rule-based asset allocation, the method being implemented by at least one processor, the method comprising:
onboarding, by the at least one processor via a graphical user interface, at least one client based on corresponding client information;
generating, by the at least one processor, at least one rule that corresponds to the at least one client, the at least one rule relating to an asset allocation rule;
retrieving, by the at least one processor via an application programming interface, asset portfolio information that corresponds to the at least one client;
determining, by the at least one processor, at least one allocation action based on the at least one rule and the asset portfolio information; and
automatically initiating, by the at least one processor in real-time, the at least one allocation action.

2. The method of claim 1, wherein generating the at least one rule further comprises:
identifying, by the at least one processor, at least one predetermined criterion from the corresponding client information;
generating, by the at least one processor, the at least one rule based on the at least one predetermined criterion, the at least one rule including software code that implements the at least one predetermined criterion; and
initiating, by the at least one processor, at least one testing action for the generated at least one rule, the at least one testing action including a user acceptance testing action.

3. The method of claim 2, wherein the at least one predetermined criterion includes a daily net target allocation criterion that relates to maintaining a target balance for an asset portfolio and a daily end of day round-trip criterion that relates to offsetting transactions for the asset portfolio.

4. The method of claim 1, further comprising:
automatically generating, by the at least one processor, at least one log for each of the initiated at least one allocation action, the at least one log including information that relates to the at least one client, the at least one rule, the asset portfolio information, and the at least one allocation action;
associating, by the at least one processor, the at least one log with the corresponding at least one client; and
persisting, by the at least one processor, the at least one log together with the association in a repository.

5. The method of claim 1, further comprising:
automatically generating, by the at least one processor in real-time, a notification for each of the initiated at least one allocation action, the notification including information that relates to the at least one rule, the asset portfolio information, and the at least one allocation action; and
transmitting, by the at least one processor, the notification to the corresponding at least one client.

6. The method of claim 1, further comprising:
automatically determining, by the at least one processor, at least one error condition when the at least one allocation action is not successfully initiated;
generating, by the at least one processor, an alert for each of the at least one error condition, the alert including information that relates to the at least one allocation action and the at least one error condition; and
transmitting, by the at least one processor, the alert to at least one responsible party.

7. The method of claim 6, further comprising:
automatically determining, by the at least one processor based on at least one predetermined resolution guideline, at least one resolution action for each of the at least one error condition; and
automatically initiating, by the at least one processor, the at least one resolution action to resolve the corresponding at least one error condition.

8. The method of claim 7, further comprising:
automatically determining, by the at least one processor, a severity level for each of the at least one error condition according to a predetermined severity guideline;
ranking, by the at least one processor, the at least one error condition based on the severity level; and
automatically initiating, by the at least one processor, the at least one resolution action based on a result of the ranking,
wherein the severity level is automatically determined by using information that relates to the at least one allocation action and the at least one error condition.

9. The method of claim 1, wherein the at least one allocation action includes an equal and offsetting action that is scheduled for a predetermined time, the predetermined time including a future time when the at least one allocation action is automatically initiated.

10. A computing device configured to implement an execution of a method for facilitating automated rule-based asset allocation, the computing device comprising:
a processor;
a memory; and
a communication interface coupled to each of the processor and the memory,
wherein the processor is configured to:
onboard, via a graphical user interface, at least one client based on corresponding client information;
generate at least one rule that corresponds to the at least one client, the at least one rule relating to an asset allocation rule;
retrieve, via an application programming interface, asset portfolio information that corresponds to the at least one client;
determine at least one allocation action based on the at least one rule and the asset portfolio information; and
automatically initiate, in real-time, the at least one allocation action.

11. The computing device of claim 10, wherein, to generate the at least one rule, the processor is further configured to:
identify at least one predetermined criterion from the corresponding client information;
generate the at least one rule based on the at least one predetermined criterion, the at least one rule including software code that implements the at least one predetermined criterion; and
initiate at least one testing action for the generated at least one rule, the at least one testing action including a user acceptance testing action.

12. The computing device of claim 11, wherein the at least one predetermined criterion includes a daily net target allocation criterion that relates to maintaining a target balance for an asset portfolio and a daily end of day round-trip criterion that relates to offsetting transactions for the asset portfolio.

13. The computing device of claim 10, wherein the processor is further configured to:
automatically generate at least one log for each of the initiated at least one allocation action, the at least one log including information that relates to the at least one client, the at least one rule, the asset portfolio information, and the at least one allocation action;
associate the at least one log with the corresponding at least one client; and
persist the at least one log together with the association in a repository.

14. The computing device of claim 10, wherein the processor is further configured to:
automatically generate, in real-time, a notification for each of the initiated at least one allocation action, the notification including information that relates to the at least one rule, the asset portfolio information, and the at least one allocation action; and
transmit the notification to the corresponding at least one client.

15. The computing device of claim 10, wherein the processor is further configured to:
automatically determine at least one error condition when the at least one allocation action is not successfully initiated;
generate an alert for each of the at least one error condition, the alert including information that relates to the at least one allocation action and the at least one error condition; and
transmit the alert to at least one responsible party.

16. The computing device of claim 15, wherein the processor is further configured to:
automatically determine, based on at least one predetermined resolution guideline, at least one resolution action for each of the at least one error condition; and
automatically initiate the at least one resolution action to resolve the corresponding at least one error condition.

17. The computing device of claim 16, wherein the processor is further configured to:
automatically determine a severity level for each of the at least one error condition according to a predetermined severity guideline;
rank the at least one error condition based on the severity level; and
automatically initiate the at least one resolution action based on a result of the ranking,
wherein the severity level is automatically determined by using information that relates to the at least one allocation action and the at least one error condition.

18. The computing device of claim 10, wherein the at least one allocation action includes an equal and offsetting action that is scheduled for a predetermined time, the predetermined time including a future time when the at least one allocation action is automatically initiated.

19. A non-transitory computer readable storage medium storing instructions for facilitating automated rule-based asset allocation, the storage medium comprising executable code which, when executed by a processor, causes the processor to:
onboard, via a graphical user interface, at least one client based on corresponding client information;
generate at least one rule that corresponds to the at least one client, the at least one rule relating to an asset allocation rule;
retrieve, via an application programming interface, asset portfolio information that corresponds to the at least one client;
determine at least one allocation action based on the at least one rule and the asset portfolio information; and
automatically initiate, in real-time, the at least one allocation action.

20. The storage medium of claim 19, wherein, to generate the at least one rule, the executable code, when executed by the processor, further causes the processor to:
identify at least one predetermined criterion from the corresponding client information;
generate the at least one rule based on the at least one predetermined criterion, the at least one rule including software code that implements the at least one predetermined criterion; and
initiate at least one testing action for the generated at least one rule, the at least one testing action including a user acceptance testing action.
